(19) United States
(12) Patent Application Publication
(10) Pub. No.: US 2008/0127333 A1
(43) Pub. Date: May 29, 2008

(54) Verification Authentication System and Method

(76) Inventor: Raffi T. Gabriel, North Hills, CA (US)

Correspondence Address: WASSERMAN, COMDEN & CASSELMAN, L.L.P., 5567 RESEDA BOULEVARD, SUITE 330, TARZANA, CA, 91357-7033, US

(21) Appl. No.: 11/834,504

(22) Filed: Aug. 6, 2007

Related U.S. Application Data
(60) Provisional application No. 60/821,395, filed on Aug. 4, 2006.

(51) Int. Cl. G06F 21/00

(52) U.S. Cl. 726/21

(57) ABSTRACT

A verification authentication system and method is provided. The verification authentication system verifies and authenticates a user seeking access to use or information. The verification authentication system is comprised of a first content and user identity, a verifying unit, and a computer authentication system. The first content and identity are verified and inputted into the computer authentication system by the verifying unit. The computer authentication system includes at least one database, a processor, a memory operatively coupled to the processor, a generator module which executes in the processor, from the memory, where logic is configured to cause the generation of a corresponding second content. In order to access use or information, the user inputs the second content into the computer authentication system. The first content and the second content are authenticated within the system and information is provided.

### CROSS-REFERENCE TO RELATED APPLICATION

This application claims priority to U.S. Provisional Patent Application No. 60/821,395, filed on the 4 Aug. 2006, and is incorporated by reference as if fully set forth within.

### BACKGROUND

1) Field of the Invention

The present invention relates generally to the field of network security. In particular, the invention relates to a system and method for verification and authentication of a user.

2) Discussion of the Related Art

The Internet has matured into a critical every day tool. The majority of people and businesses rely on the Internet to accomplish every day tasks. However, the anonymity that accompanies the Internet has caused concern. Specifically, there have been many concerns regarding sexual predators on social networks. Concerns of these types on social networks and/or certain “age-sensitive” sites have been mounting in recent years and have been profiled in recent news.

Although unheard of just a few years ago, social networking sites are now among the most-trafficked on the Internet. Generally, to access such sites, the user only needs a user name and a password, which may be received with an email address. The addition of extra security measures, including a credit card or social security number can easily be stolen and used, adding no layer of protection to young users online.

Federal and state officials have proposed legislation in response to these growing concerns. The prompted legislation bans access to such sites in federally funded schools and libraries. However, such legislation does not provide the proper solution to the problem. Several state Attorney Generals have suggested that such sites “age-verify” all their users and to exclude some users over or under a certain age limits. However, current methods serving to age-verify are fraught with problems of fraud and misrepresentation.

One of the largest social networks is located at www.myspace.com, hereinafter “MySpace.” This social network has received the majority of the complaints given its leadership with more than 93 million registered users, 20% of which are under 18. MySpace has moved proactively to combat these issues by implementing policies designed to better separate kids from adults. Among the changes, adult MySpace users must already know a child user's e-mail address or full name to initiate contact or view a profile containing personal information. While this is a step to remedy the problem, because age is self-reported, adult predators could simply sign up as minors. MySpace has also announced a program called “Zephyr” which will allow parents to access their children's accounts. This program lists all MySpace users who have logged on to the service using that particular computer, unfortunately the program only shows limited data and does not provide verification and authentication of a user.

In order to remedy the concerns on social networks, the justice system must be more rigorous in prosecuting such offenders and/or there must be more open dialogue about the dangers associated with such sites and the safety of children. However, these measures apply after the fact and as preventative measures, respectively.

Currently, direct measures include checking addresses, birth dates and other information users provide against public databases, such as voting and property records. However, this works best with adults, as children do vote, drive or generally own property, making teens harder to verify.

While the above-mentioned measures are a step in the right direction, they lack in many respects and do not solve the online social network problem. Though it may sacrifice anonymity, information presented online must be reconciled in a verified and authenticated database.

### BRIEF DESCRIPTION OF THE DRAWINGS

The invention is described by way of example with reference to the accompanying drawings where:

FIG. 1 illustrates a verification authentication system, including a verifying unit and a computer authentication system.

FIG. 2 illustrates a flow chart of the verification authentication system, generating a second content for a user.

FIG. 3 illustrates the user and the computer authentication system.

FIG. 4 illustrates a flow chart of the user accessing information through the authentication computer system.

FIG. 5 illustrates an input/output device wirelessly accessing the computer authentication system.

### DETAILED DESCRIPTION OF THE INVENTION

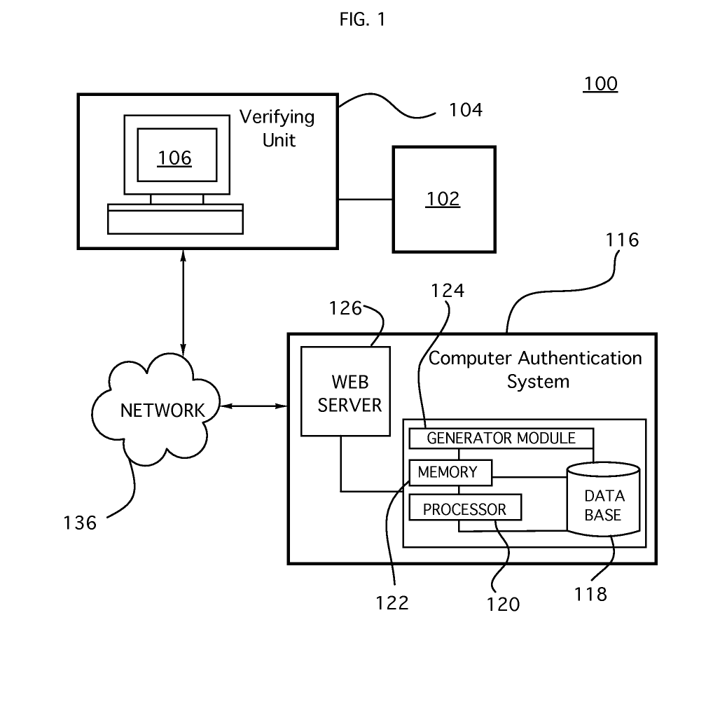

FIG. 1 illustrates a verification authentication system 100. The verification authorization system 100 verifies and authorizes users in accessing; information, use, or other secured area or equipment. The verification authorization system 100 is comprised of a verifying unit 104 and a computer authentication system 116.

The verifying unit 104 includes a client 106, which connects a user 102 to the authentication computer system 116. The authentication computer system 116 is comprised of at least one database 118, a processor 120, a memory 122 operatively coupled to the processor 120, and a generator module 124, which executes in the processor 120.

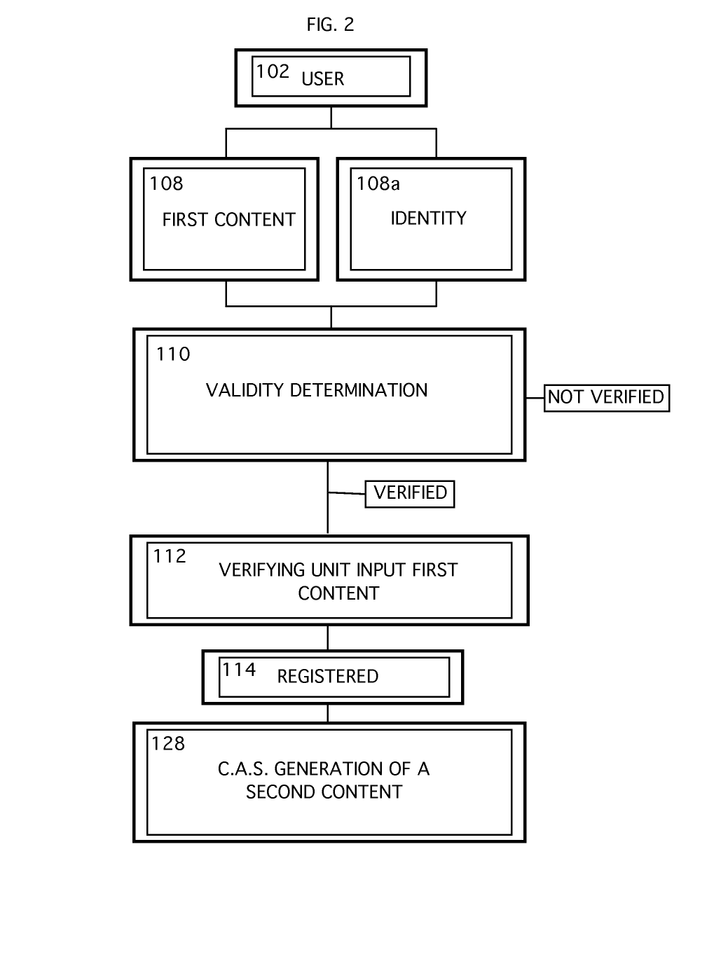

FIG. 2 illustrates the use of the verification authorization system 100 by the user 102. The user 102 presents a first content 108 and user identity 108a to the verifying unit 104. The verifying unit 104 determines the validity 110 of the first content 108 and the identity 108a of the user 102. The first content 108 and identity 108a are verified by the verifying unit 104, and upon verification, the verifying unit 104 accesses the computer authentication system 116 and inputs 112 the first content 108 into the computer authentication system 116. If the first content 108 and the identity 108a do not correspond they are not verified and not inputted into the computer authentication system 116.

After the computer authentication system 116 receives the first content 108, the computer authentication system 116 registers 114 the user 102 and generates a corresponding second content 128. The second content 128 is associated with the first content 108 within the authentication computer system 116. The generator module 124 executes in the processor 120, from the memory 122, where logic is configured to cause the generation of the corresponding second content 128 upon receiving the first content 108 inputted from the verifying unit 104. The user 102 then receives the second content 128.

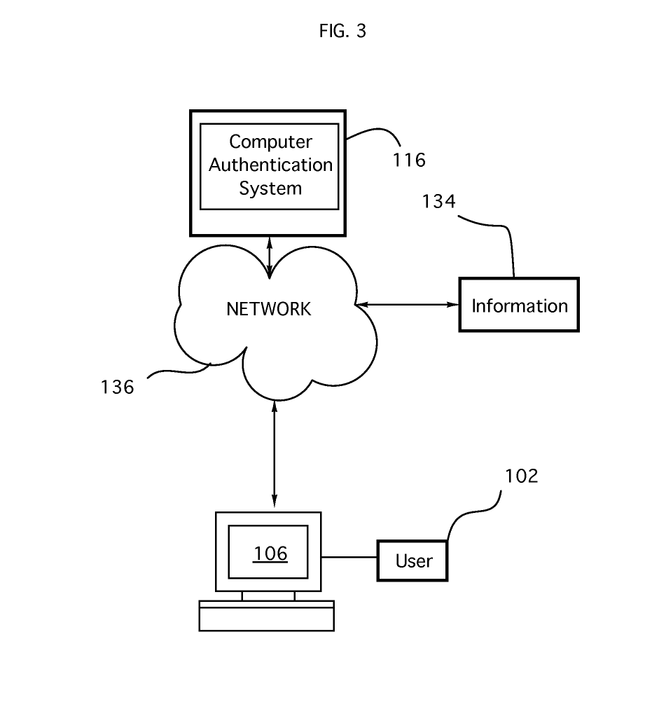

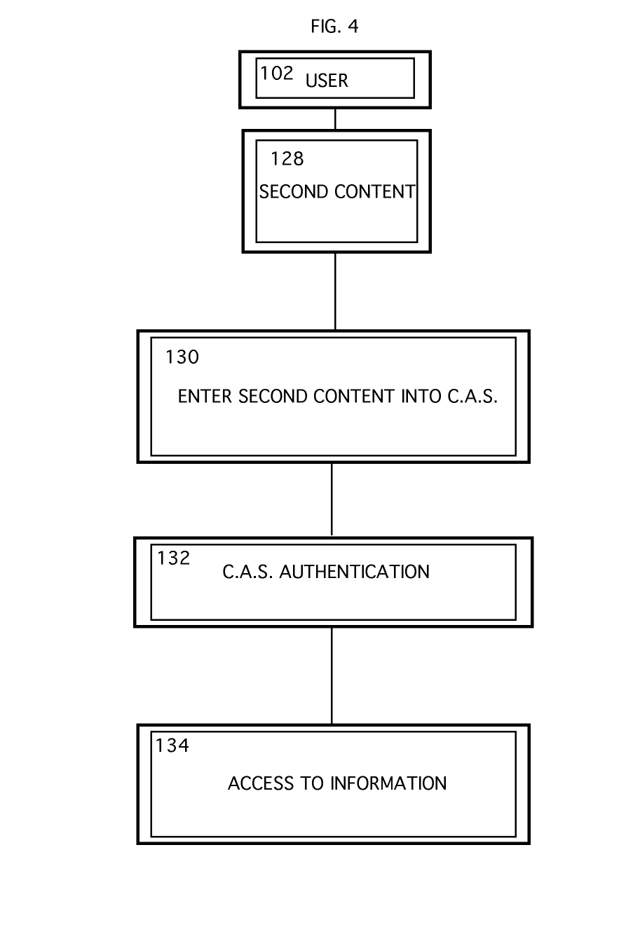

FIG. 3 illustrates the user 102, the computer authentication system 116, and information 134, over a network 136. FIG. 4 illustrates the user 102, after having received the second content 128. The user 102, including the use of a client 106, accesses and inputs 130 the second content 128 into the computer authentication system 116. The computer authentication system 116 receives and authenticates 132 the second content 128 and the first content 108 stored on the at least one database 118, allowing the user 102 access to the information 134.

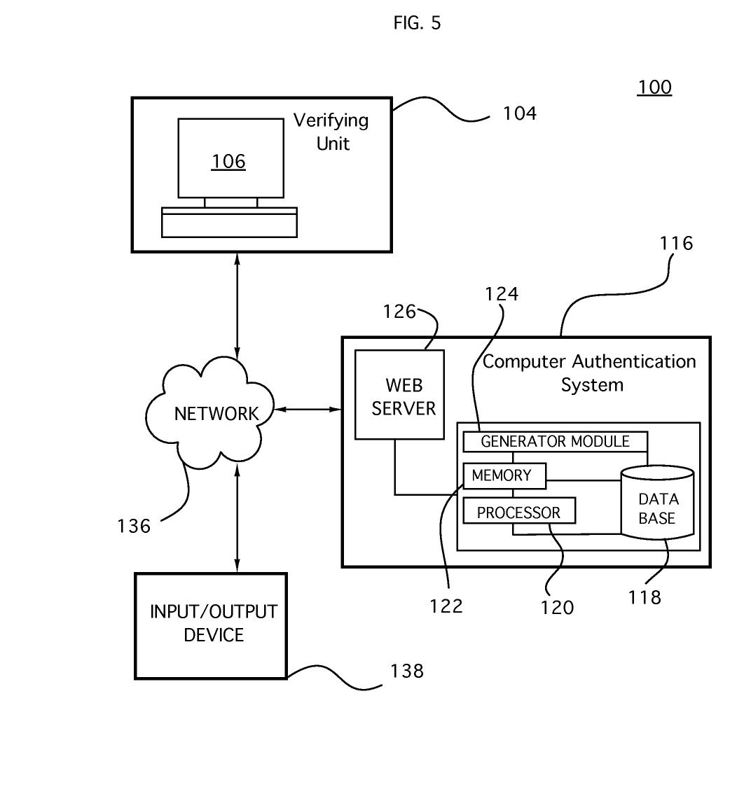

FIG. 5 illustrates an input/output device wirelessly contacting the computer authentication system 116. After the user 102 receives the second content 128, upon providing a first content 108 to the input/output device, the device contacts the computer authentication system 116. The input/output device is wireless, transmitting information by radio frequency or other wireless method, allowing the user 102 access to the use or information associated with the input/output device.

In use, the user 102 supplies the first content 108 to the verifying unit 104. In an embodiment the first content 108 is comprised of government data, i.e. drivers license, passport, birth certificate or other licenses or forms. In another embodiment, the first content is unique to the user, comprising biometric data, such as deoxyribonucleic acid (DNA), ribonucleic acid (RNA), protein, fingerprint, thermal scan, voiceprint, facial recognition, and retinal scan.

The verifying unit 104 determines the validity of the first content 108 and the identity 108a. The verifying unit 104 is an examining authority or agency, under legal authority. In an embodiment, the verifying unit 104 is an individual authorized by the government. In another embodiment, the verifying unit 104 is a notary public. A notary public is an officer who can administer oaths, act as a witness, authenticate documents and perform other acts consistent with the licensing jurisdiction.

The verifying unit 104, upon verification or validity determination 110, inputs the first content 112 into the computer authentication system 116. In one embodiment, the computer authentication system 116 includes a web server 126 on the network 136. The network 136, in one embodiment is a local area network or LAN. In another embodiment, the network 136 is the Internet or the World Wide Web.

After the verifying unit 104 inputs the first content 108 into the computer authentication system 116, the computer authentication system 116 stores the first content 108 on the at least one database 118 and generates the second content 128 corresponding to the first content 108. In one embodiment, the second content 128 is randomly generated characters. In another embodiment, the second content 128 is a user name and password. In yet another embodiment, the at least one database 118 includes a registry of users. In another embodiment, users who were not verified are stored in a registry of the at least one database 118.

The user 102 then receives the second content 128. The receipt of this content is done outside the presence of the verifying unit 104, ensuring security. The second content 128 can then be used to access information 134. In one embodiment the user 102 inputs the second content 128 into the computer authentication system 116, and accesses information 134 from a wireless device.

In embodiment, the input/out device inputs the second content 128. The input/output device wirelessly connects the computer authentication system 116. The input/output device connects wirelessly, including by radio frequency to the computer authentication system 116. In this embodiment, a user 102 is verified, and the authentication of the user 102 takes place remotely from the input/output device, wirelessly. In an embodiment, the user 102 is accessing the use of equipment or to gain entry into a secured area. The user 102 provides a first content 108, i.e. a thumbprint, to the input/output device. The input/output device transmits the first content 108 to the computer authentication system 116. Upon authentication, the user 102 is allowed use or otherwise access, the input/output device or other connected thereto.

The computer authentication system 116 may be accessed in different environments. In an embodiment, the user 102 inputs 130 the second content 128 directly into the computer authentication system 116 based website. Affiliate websites may then link to the server and allow users 102 after authentication. In another embodiment, the computer authentication system 116 is a browser based interface to websites, intranet, extranet, groupware, search engines, or similar, also known as a web portal.

The web portal is a web site that provides a starting point or a gateway to other resources on the Internet or an intranet. In this embodiment, the computer authentication system 116 has a login interface within affiliate websites. As above, the user 102 logs into the web portal with the second content 128, which upon authorization, allows access between the user 102 and the information 134.

The verification authentication system functions as a central authority for online communities. The system creates an online database of registered users who are verified by an authorized official or notary public, rather than web browsers alone. The system and method allows the integration of traditional identity verification methods with the latest in web technology.

An advantage of this invention is the establishment of a licensed authority. Providing this unit or individual will vet those who intend to cause harm online by being someone they are not. Another advantage of the invention is that by using such authorities, which are widespread across the country, the system and method allows for large-scale registration and accessibility, providing convenience for information seeking users.

While certain exemplary embodiments have been described and shown in the accompanying drawings, it is to be understood that such embodiments are merely illustrative and not restrictive of the current invention, and that this invention is not restricted to the specific constructions and arrangements shown and described since modification may occur to those ordinarily skilled in the art.

What is claimed:

1. A verification authentication system authorizing a user to access information, the system comprising:
a first content;
a verifying unit;
a user identity, the first content and the identity verified by the verifying unit; and
a computer authentication system including, at least one database, a processor, a memory operatively coupled to the processor, a generator module which executes in the processor, from the memory, where logic is configured to cause the generation of a second content upon receiving the first content inputted from the verifying unit, wherein access is provided to the user after authentication of the second content and the first content stored on the at least one database, correspond.

2. The system of claim 1, wherein the first content is unique to the user.

3. The system of claim 1, wherein the first content is government data.

4. The system of claim 1, wherein the verifying unit is an individual authorized by the government.

5. The system of claim 4, wherein the verifying unit is a notary.

6. The system of claim 1, wherein the computer authentication system includes a server on a network.

7. The system of claim 6, wherein the network is the Internet.

8. The system of claim 7, wherein the computer authentication system is associated with a gateway.

9. The system of claim 1, wherein the user inputs the second content from a wireless device.

10. The system of claim 1, wherein the second content is randomly generated characters, including a user name and password.

11. The system of claim 1, wherein an input/output device transmits the second content to the computer authentication system.

12. A method of verifying and authenticating a user to access information, the method comprising:
receiving a first content and an identity to a verifying unit;
verifying the first content and the identity;
receiving the first content by an computer authentication system comprising, at least one database, a processor, a memory operatively coupled to the processor, a generator module which executes in the processor, from the memory, where logic is configured to cause the generation of a second content upon receiving a first content; and
authenticating the user, wherein access is provided to the user after the second content and the first content, stored within the database, correspond.

13. The method of claim 12, wherein the first content is unique to the user.

14. The method of claim 12, wherein the first content is government data.

15. The method of claim 12, wherein the verifying unit is an individual authorized by the government.

16. The method of claim 15, wherein the verifying unit is a notary.

17. The method of claim 12, wherein the computer authentication system includes a server on a network.

18. The method of claim 17, wherein the network is the Internet.

19. The method of claim 18, wherein the computer authentication system is associated with a web portal.

20. The method of claim 12, wherein the user inputs the second content from a wireless device.

21. The method of claim 12, wherein the second content is randomly generated characters, including a user name and password.

22. The method of claim 12, wherein an input/output device transmits the second content to the computer authentication system.
